(19) United States
(12) Patent Application Publication
(10) Pub. No.: US 2026/0012628 A1
(43) Pub. Date: Jan. 8, 2026

(54) INTER-FRAME CODING MOTION VECTOR PROCESSING METHOD AND APPARATUS

(71) Applicant: Glenfly Tech Co., Ltd., Shanghai (CN)

(72) Inventors: Bo HE, Shanghai (CN); Cong ZHU, Shanghai (CN); Wu HAO, Shanghai (CN); Cong JI, Shanghai (CN)

(21) Appl. No.: 19/028,617

(22) Filed: Jan. 17, 2025

(30) Foreign Application Priority Data
Jul. 2, 2024 (CN) 202410882714.3

(51) Int. Cl. H04N 19/513; H04N 19/176

(52) U.S. Cl. CPC H04N 19/513; H04N 19/176

(57) ABSTRACT

The present disclosure relates to an inter-frame coding motion vector processing method and apparatus. The method includes: acquiring an estimated motion vector between a current coded image block and a reference frame coded image block and a position number of the estimated motion vector; reading merge motion vector information corresponding to the position number from a target merge table according to the position number of the estimated motion vector; the target merge table including a relationship between position numbers of estimated motion vectors and merge motion vector information corresponding to the position numbers of the estimated motion vectors; and replacing the estimated motion vector corresponding to the 10 position number with the merge motion vector information, and coding the merge motion vector information. By use of the method, the time of deciding a candidate motion vector in a video inter-frame coding merge mode can be reduced, thereby improving computing efficiency.

### CROSS REFERENCE TO RELATED APPLICATIONS

This application claims priority under 35 U.S.C. § 119 to Chinese Patent Application No. 2024108827143, filed on Jul. 2, 2024, the entire content of which is incorporated herein in its entirety.

### TECHNICAL FIELD

The present disclosure relates to the field of video coding technologies, and in particular, to an inter-frame coding motion vector processing method and apparatus.

### BACKGROUND

With the popularity of ultra-high definition video content, an amount of data for video coding continues to increase, a merge mode in inter-frame estimation can reduce an amount of coding of estimated motion vector (est_mv) data of a current block by referencing motion information of a coded neighboring block, thereby reducing redundant information of coding and improving coding efficiency. After testing, after the merge mode is enabled, the coding efficiency may be improved by about 2.5% on average.

In High Efficiency Video Coding (HEVC), in the merge mode, before a motion vector search, 7 motion vector predicted values are generated based on a coded neighboring block and a coded frame neighboring block of a current frame, and 5 motion vector predicted values are selected as candidate motion vectors (cand_mv) for merge according to priority provisions in a protocol, which are inputted to an integer pixel motion vector search unit in order of priorities, and iterative comparison is performed in the motion vector search unit to select an optimal merge motion vector (merge_mv).

In the conventional art, in an integer pixel search of motion estimation, a merge estimation operation may be required. In order to balance a search speed and accuracy of search results, the integer pixel search may generally be performed in a range of 8*8. Each est_mv within the search range of 8*8 may be sequentially independently compared with the 5 cand_mv in a merge candidate list. For 8*8 est_mv, each est_mv requires 5 cycles. Then, the entire search region requires 320 cycles for merge comparison. Even if a technology of calculating adjacent est_mv in parallel is used, 160 cycles are required. For testing of the integer pixel search in the conventional manner, when a minimum coding unit (CU) is divided, an integer pixel search stage of a CU block takes about 237 cycles, and the merge comparison takes about 67%. When a maximum CU is divided, an integer pixel search stage of a CU block takes about 412 cycles, and the merge comparison takes up about 39%.

Obviously, a conventional method for calculating a merge mode requires a large number of iterative comparison operations and takes up a longer coding time. As complexity of the video content increases, the operation becomes more time-consuming, resulting in inefficient coding.

### SUMMARY

Based on this, there is a need to provide, with respect to the above technical problems, an inter-frame coding motion vector processing method and apparatus that can reduce the time of deciding inter-frame coding motion vector merge and improve computing efficiency.

In a first aspect, the present disclosure provides an inter-frame coding motion vector processing method.

An inter-frame coding motion vector processing method, including:
acquiring an estimated motion vector between a current coded image block and a reference frame coded image block and a position number of the estimated motion vector;
reading merge motion vector information corresponding to the position number from a target merge table according to the position number of the estimated motion vector; the target merge table including a relationship between position numbers of estimated motion vectors and merge motion vector information corresponding to the position numbers of the estimated motion vectors; and
replacing the estimated motion vector corresponding to the position number with the merge motion vector information, and coding the merge motion vector information.

In an embodiment, target candidate motion vector information carries a number; and the target merge table is constructed by:
acquiring a search range;
sequentially acquiring the target candidate motion vector information from a candidate list in order of numbers;
acquiring, for each piece of the target candidate motion vector information within
the search range, merge motion vector information corresponding to the target candidate motion vector information in a case that a preset condition is met, wherein the merge motion vector information is determined based on the position number of the estimated motion vector; and
obtaining the target merge table according to the target candidate motion vector information and the merge motion vector information corresponding to the target candidate motion vector information, a size of the target merge table being the same as the search range.

In an embodiment, acquiring the merge motion vector information corresponding to the target candidate motion vector information includes:
performing sub-pixel component determination on the target candidate motion vector information; and
determining the merge motion vector information corresponding to the target candidate motion vector information based on a sub-pixel component determination result.

In an embodiment, the target candidate motion vector information includes a first component and a second component; and determining the merge motion vector information corresponding to the target candidate motion vector information based on the sub-pixel component determination result includes:
acquiring, if the first component and the second component are both sub-pixel components, position numbers of a first number of estimated motion vectors in a neighborhood of the target candidate motion vector information;
marking the position numbers of the first number of estimated motion vectors as the merge motion vector information;
acquiring, if only one of the first component and the second component is a sub- pixel component, position numbers of a second number of estimated motion vectors in the neighborhood of the target candidate motion vector information; wherein the first number is greater than the second number;
marking the position numbers of the second number of estimated motion vectors as the merge motion vector information; and
acquiring, if neither the first component nor the second component is a sub-pixel component, a position number of an estimated motion vector corresponding to the target candidate motion vector information, and marking the position number as the merge motion vector information.

In an embodiment, obtaining the target merge table according to the target candidate motion vector information and the merge motion vector information corresponding to the target candidate motion vector information includes:
sequentially acquiring the target candidate motion vector information and position numbers of estimated motion vectors in the neighborhood of the target candidate motion vector information in order of numbers;
acquiring position numbers of estimated motion vectors in a neighborhood of historical candidate motion vector information of the target candidate motion vector information;
determining whether the position numbers of the estimated motion vectors in the neighborhood of the target candidate motion vector information are the same as the position numbers of the estimated motion vectors in the neighborhood of the historical candidate motion vector information, and if the position numbers are the same, taking the estimated motion vectors that overlap as first estimated motion vectors;
if the position numbers are not the same, taking the estimated motion vectors that do not overlap as second estimated motion vectors; and
iteratively saving the first estimated motion vectors and saving the second estimated motion vectors to obtain an initial merge table until all target candidate motion vector information in the candidate list is saved, to obtain the target merge table.

In an embodiment, iteratively saving the first estimated motion vectors and saving the second estimated motion vectors to obtain the initial merge table includes:
saving the target candidate motion vector information by taking position numbers of the first estimated motion vectors and position numbers of the second estimated motion vectors after iteration in the neighborhood of the target candidate motion vector information as indexes, to obtain the initial merge table.

In an embodiment, the target candidate motion vector information includes a target merge type and a target distance, and prior to taking the position numbers of the first estimated motion vectors after iteration in the neighborhood of the target candidate motion vector information as the indexes, the method includes:
reading, when the search range is an integer pixel search range, a first merge type and a first distance corresponding to the first estimated motion vectors from the initial merge table, wherein the first merge type is determined based on the historical candidate motion vector information of the target candidate motion vector information, and the first distance indicates a distance between the historical candidate motion vector and the estimated motion vector of the target candidate motion vector information;
determining priorities of the target merge type and the first merge type;
replacing, if the priority of the target merge type is higher than the priority of the first merge type, the first merge type with the target merge type, and replacing the first distance with the target distance, to obtain the first estimated motion vector after iteration;
determining, if the priority of the target merge type is equal to the priority of the first merge type, whether the target distance is less than the first distance; wherein the target distance indicates a distance between a target candidate motion vector and the estimated motion vector; and
replacing, if the target distance is less than the first distance, the first distance with the target distance, to obtain the first estimated motion vector after iteration.

In an embodiment, the target candidate motion vector information includes a target merge type, and prior to taking the position numbers of the first estimated motion vectors after iteration in the neighborhood of the target candidate motion vector information as the indexes, the method includes:
reading, when the search range is a sub-pixel search range, a first merge type corresponding to the first estimated motion vectors from the initial merge table, the first merge type being determined based on the historical candidate motion vector information of the target candidate motion vector information;
determining priorities of the target merge type and the first merge type;
replacing, if the priority of the target merge type is higher than the priority of the first merge type, the first merge type with the target merge type, to obtain the first estimated motion vector after iteration.

In an embodiment, the method further includes:
acquiring a new search range; and
determining a size of the target merge table according to the new search range.

In a second aspect, the present disclosure provides an inter-frame coding motion vector processing apparatus, including:
a first acquisition module configured to acquire an estimated motion vector between a current coded image block and a reference frame coded image block and a position number of the estimated motion vector;
a reading module configured to read merge motion vector information corresponding to the position number from a target merge table according to the position number of the estimated motion vector, the target merge table including a relationship between position numbers of estimated motion vectors and merge motion vector information corresponding to the position numbers of the estimated motion vectors; and
a replacement and coding module configured to replace the estimated motion vector corresponding to the position number with the merge motion vector information, and code the merge motion vector information.

According to the above inter-frame coding motion vector processing method and apparatus, in an inter-frame coding merge mode, before an estimated motion vector is coded, candidate vectors are compared and placed in front. In the motion vector search stage, according to a position number of the estimated motion vector, the merge motion vector information corresponding to the position number is directly read from the target merge table. Position numbers of estimated motion vectors and merge motion vector information corresponding to the position numbers of the estimated motion vectors are pre-stored in the target merge table, which reduces the time of comparing each estimated motion vector with each candidate motion vector. Therefore, coding efficiency in the inter-frame coding merge mode is improved.

### BRIEF DESCRIPTION OF THE DRAWINGS

In order to more clearly illustrate the technical solutions in embodiments of the present disclosure or the related art, the accompanying drawings used in the description of the embodiments or the related art will be briefly introduced below. It is apparent that, the accompanying drawings in the following description are only some embodiments of the present disclosure, and other drawings can be obtained by those of ordinary skill in the art from the provided drawings without creative efforts.

FIG. 1 is a diagram of an application environment of an inter-frame coding motion vector processing method according to an embodiment;

FIG. 2 is a schematic flowchart of an inter-frame coding motion vector processing method according to an embodiment;

FIG. 3a is a schematic diagram of an integer pixel target merge table according to an embodiment;

FIG. 3b is a schematic diagram of a sub-pixel target merge table according to another embodiment;

FIG. 4 is a schematic flowchart of constructing a target merge table according to an embodiment;

FIG. 5 is a schematic diagram of merge mv corresponding to cand-mv according to another embodiment;

FIG. 6 is a schematic flowchart of acquiring merge motion vector information corresponding to target candidate motion vector information according to an embodiment;

FIG. 7 is a schematic flowchart of determining merge motion vector information corresponding to the target candidate motion vector information based on a sub-pixel component determination result according to an embodiment;

FIG. 8 is a schematic diagram of constructing a target merge table according to another embodiment;

FIG. 9 is a schematic diagram of integer pixel overall loop iteration according to an embodiment;

FIG. 10 is a schematic flowchart of iterating a first estimated motion vector in an initial merge table according to an embodiment;

FIG. 11 is a schematic flowchart of iterating a first estimated motion vector according to an embodiment;

FIG. 12 is a schematic flowchart of iterating a first estimated motion vector in an initial merge table according to another embodiment;

FIG. 13 is a schematic flowchart of sub-pixel overall loop iteration according to an embodiment;

FIG. 14 is a schematic flowchart of inter-frame coding motion vector processing according to an embodiment;

FIG. 15 is a structural block diagram of an inter-frame coding motion vector processing apparatus according to an embodiment; and

FIG. 16 is a diagram of an internal structure of a computer device according to an embodiment.

### DETAILED DESCRIPTION

In order to make the objectives, technical solutions, and advantages of the present disclosure clearer, the present disclosure will be further described in detail below with reference to the accompanying drawings and embodiments. It should be understood that the specific embodiments described here are only used to explain the present disclosure and are not used to limit the present disclosure.

Predictive coding mainly includes two parts, i.e., intra-frame coding and inter-frame coding. Intra-frame coding means performing compression within a single frame without relying on information from other frames. Each frame is independently coded. Inter-frame coding is a video compression technology used to reduce sizes of video files. Inter-frame coding means performing compression by using redundant information between video frames and referring to other frames (generally previous and following frames).

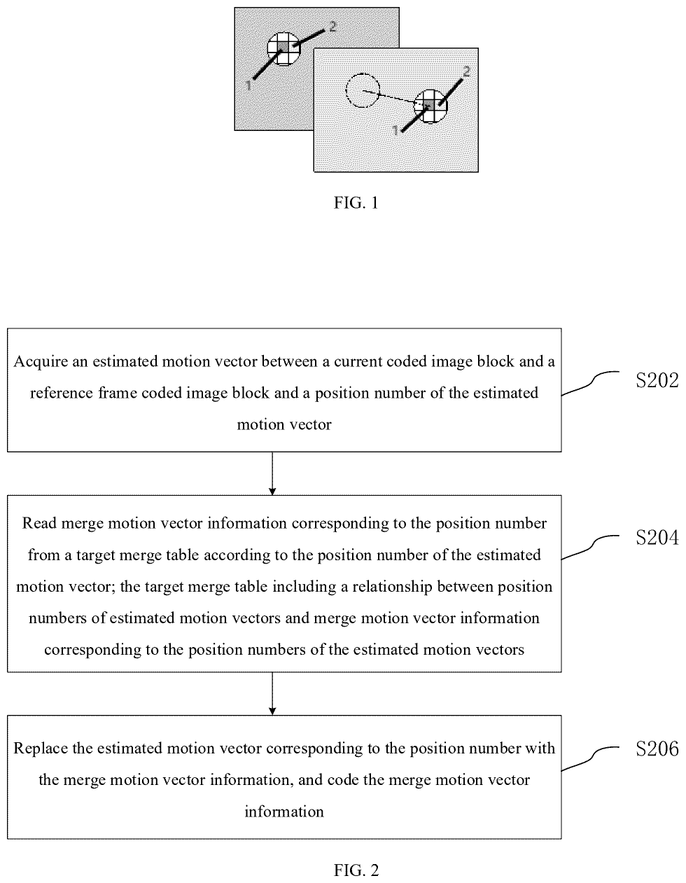

Motion estimation is required in inter-frame coding. As shown in FIG. 1, a lower layer refers to a previous frame of image or a reference frame image, and an upper layer refers to a current frame of image. In the two frames, a circular pattern moves from the left side of the image to the right side of the image. The displacement is called a motion vector.

Generally, motion vectors are estimated by dividing an image into a plurality of image blocks. The image block is an image block including a plurality of pixels. Between two frames, the pattern doesn't move too far. A reference frame coded image block is most likely around a current frame coded image block. Generally, an integer pixel search may be performed in a range of 8*8. Therefore, 64 estimated motion vectors may be obtained. As can be see, motion vectors can be determined without the merge mode.

Significance of the merge mode is that, as shown in FIG. 1, if a motion vector of an image block 1 has been determined, the motion vector may be calculated to serve as a candidate motion vector of an image block 2. When the estimated motion vector points to an image block of a previous frame and then the closest image block is obtained by comparison, if the estimated motion vector includes a merge motion vector, the estimated motion vector is replaced with a number of the merge motion vector. It may be thought that directly coding an estimated motion vector may definitely require a much larger amount of coding than coding the number of the merge motion vector. Therefore, the amount of coding can be reduced in the merge mode, thereby improving coding efficiency.

In the merge mode, before a motion vector search, 7 motion vector predicted values are generated based on a coded neighboring block and a coded frame neighboring block of a current frame, and 5 motion vector predicted values are selected as candidate motion vectors (cand_mv) for merge according to priority provisions in a protocol, which are inputted to an integer pixel motion vector search unit in order of priorities, and iterative comparison is performed in the motion vector search unit to select an optimal merge motion vector (merge_mv).

In an integer pixel search of motion estimation, a merge estimation operation may be required. In order to balance a search speed and accuracy of search results, each est_mv within the search range of 8*8 may be sequentially independently compared with 5 cand_mv in a merge candidate list. However, a merge comparison time during the motion estimation is excessively long. Therefore, by constructing a target merge table, position numbers of estimated motion vectors and merge motion vector information corresponding to the position numbers of the estimated motion vectors are pre-stored in the target merge table. In a motion vector search stage, according to the position number of the estimated motion vector, the merge motion vector information in the target merge table is read without consuming additional cycles.

In an exemplary embodiment, as shown in FIG. 2, an inter-frame coding motion vector processing method is provided. For example, the method is applied to a server in FIG. 1, including step S202 to step S206 below.

In step S202, an estimated motion vector between a current coded image block and a reference frame coded image block and a position number of the estimated motion vector are acquired.

Optionally, the server acquires the estimated motion vector between the current coded image block and the reference frame coded image block. The current coded image block is located in a current frame of image. Generally, the integer pixel search may be performed in the range of 8*8, and 64 estimated motion vectors may be obtained. Each estimated motion vector corresponds to a position number. A position of each estimated motion vector may be determined according to the position number. For example, taking an upper left corner as an origin of a coordinate axis, the abscissa (X-axis) is 1 to 8 sequentially from left to right, and the ordinate (Y-axis) is 1 to 8 sequentially from top to bottom. The position number of each estimated motion vector may be represented by (X, Y) coordinates or identified by other symbols. For example, in the range of 8*8, the first row may be denoted as A1 to A8, the second line row may be denoted as B1 to B8, and so on, to identify the position numbers of the 64 estimated motion vectors. The position number may be in any reasonable form, which is not specifically limited herein.

In step S204, merge motion vector information corresponding to the position number is read from a target merge table according to the position number of the estimated motion vector, the target merge table including a relationship between position numbers of estimated motion vectors and merge motion vector information corresponding to the position numbers of the estimated motion vectors.

The target merge table includes position numbers of estimated motion vectors and merge motion vector information corresponding to the position numbers of the estimated motion vectors. The target merge table may be either an integer pixel target merge table or a sub-pixel target merge table. All merge candidate vector information within the search range in the candidate list has been pre-stored in the target merge table.

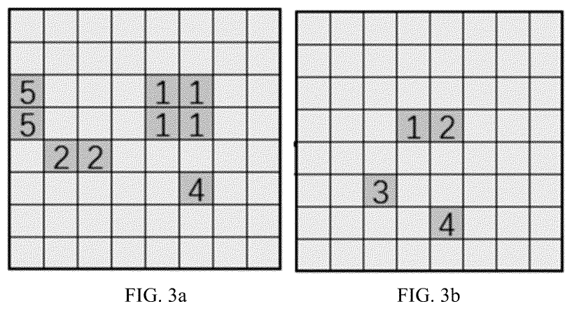

Optionally, taking the above coordinates as an example to represent the position number, FIG. 3a shows an integer pixel target merge table, and merge motion vector information of an estimated candidate vector with a position number (5,3) is 1.

FIG. 3b shows a target merge table of sub-pixels. Taking the upper left corner as the origin of the coordinate axis, in the range of 8*8, the abscissa is ¼-2 sequentially from left to right, and the ordinate is the same. For example, merge motion vector information corresponding to a position number ( 5/4,1) is 2.

Optionally, in integer pixel target merge, for example, in FIG. 3a, the server may read, according to the position number of the estimated motion vector, for example, (5,3), merge motion vector information 1 corresponding to (5,3) from the integer pixel target merge.

Optionally, in sub-pixel target merge, for example, in FIG. 3b, the server may read, according to the position number of the estimated motion vector, for example, ( 5/4,1), merge motion vector information 2 corresponding to ( 5/4,1) from the integer pixel target merge.

In step S206, the estimated motion vector with the corresponding position number is replaced with the merge motion vector information, and the merge motion vector information is coded.

Optionally, since directly coding an estimated motion vector may definitely require a much larger amount of coding than coding the number of the merge motion vector, the server replaces the estimated motion vector corresponding to the position number with the merge motion vector information, and codes the merge motion vector information. Therefore, the amount of coding can be reduced in the merge mode, thereby improving coding efficiency.

In the above inter-frame coding motion vector processing method, in an inter-frame coding merge mode, before an estimated motion vector is coded, candidate vectors are compared and placed in front. In the motion vector search stage, according to a position number of the estimated motion vector, the merge motion vector information corresponding to the position number is directly read from the target merge table. Position numbers of estimated motion vectors and merge motion vector information corresponding to the position numbers of the estimated motion vectors are pre-stored in the target merge table, which reduces the time of comparing each estimated motion vector with each candidate motion vector. Therefore, coding efficiency in the inter-frame coding merge mode is improved.

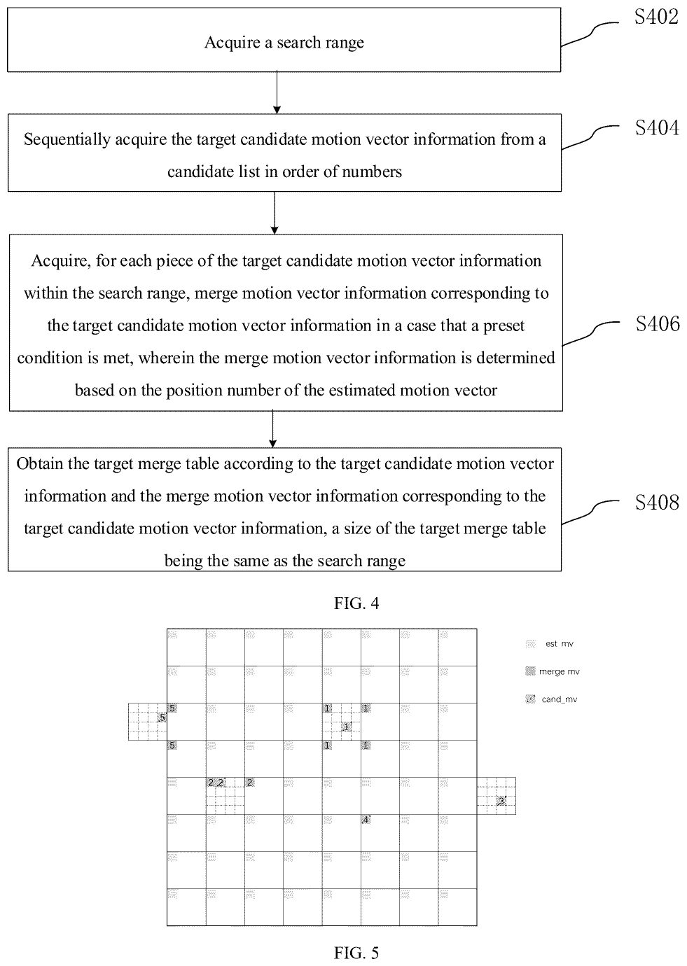

In an exemplary embodiment, as shown in FIG. 4, target candidate motion vector information carries a number, and the target merge table is constructed by step S402 to step S408.

In step S402, a search range is acquired.

The search range may be an integer pixel search range or a sub-pixel search range.

Optionally, the server acquires the integer pixel search range. Assuming that the integer pixel search range is an 8*8 region and surrounding regions less than 1 pixel, the search range is denoted as ({0<mvx<9}, {0<mvy<9}).

Optionally, the server acquires the integer pixel search range such as ({0<mvx<2}, {0≤mvy<2}).

In step S404, the target candidate motion vector information is sequentially acquired from a candidate list in order of numbers.

Candidate motion vectors may be one-quarter pixels or one-eighth pixels. That is, the candidate motion vectors may be sub-pixels. If a search range of the candidate motion vectors is an integer pixel search range, an integer pixel target merge table is constructed accordingly. If the search range of candidate motion vectors is a sub-pixel search range, a sub-pixel target merge table is constructed accordingly.

In practical applications, for a predictive CU, up to 5 pieces of candidate motion vector information cand_mv are stored in the candidate list, which are cand_mv1, cand_mv2, cand_mv3, cand_mv4, and cand_mv5 respectively.

Optionally, the server sequentially acquires the target candidate motion vector information in order of numbers. The target candidate motion vector information may be any candidate motion vector information in the candidate list, such as cand_mv1, or other candidate motion vector information.

In practical applications, increasing a number of cand_mv is a manner of increasing probability of est_mv merge. Cand_mv may be increased adaptively. In a conventional processing manner, if the number of cand_mv increases by 1, merge iterative comparison time may increase by 32 cycles, thereby greatly increasing the entire inter-frame estimation time. However, in this embodiment, almost no additional time is consumed, reducing an influence of expansion of the number of cand_mv on timing of peripheral modules.

In step S406, for each piece of the target candidate motion vector information within the search range, merge motion vector information corresponding to the target candidate motion vector information is acquired in a case that a preset condition is met, wherein the merge motion vector information is determined based on the position number of the estimated motion vector.

The merge motion vector information is determined based on the position number of the estimated motion vector. The preset condition may be a number of a merge type of cand_mv being greater than 0.

Merge types are mainly semi-merge, rectangular merge, and square merge. Each predictive CU may be of the semi-merge type, a rectangularly divided pu may be of the rectangular merge type, and a square pu may be of the square merge type. A priority of the semi-merge is lower than that of the rectangular merge and the square merge. The merge types are numbered according to priorities.

TABLE 1
Numbers of merge types

| | | | Rectangular | |
|---|---|---|---|---|
| Merge type | Non-merge | Semi-merge | merge | Square merge |
| Number | 0 | 1 | 2 | 3 |

Optionally, the server makes the following determination on cand_mv1 to determine whether two components mvx and mvy of cand_mv1 fall within the search range ({0<mvx<9}, {0<mvy<9}), if the two components fall within the range, determines whether cand_mv1 meets a preset condition (e.g., the preset condition may be the number of the merge type of cand_mv1 being greater than 0), and if cand_mv1 also meets the preset condition, acquires merge motion vector information corresponding to cand_mv1. In this case, the merge motion vector information corresponding to cand_mv1 is saved.

Optionally, after saving the merge motion vector information corresponding to cand_mv1 (in this case, target candidate motion vector information is cand_mv2), the server continuously determines whether two components mvx and mvy of cand_mv2 fall within the search range ({0<mvx<9}, {0<mvy<9}), if the two components fall within the range, determines whether cand_mv2 meets a preset condition (e.g., the preset condition may be the number of the merge type of cand_mv1 being greater than 0), and if cand_mv2 also meets the preset condition, acquires merge motion vector information corresponding to cand_mv2. In this case, the merge motion vector information corresponding to cand_mv2 is saved.

In step S408, the target merge table is obtained according to the target candidate motion vector information and the merge motion vector information corresponding to the target candidate motion vector information, a size of the target merge table being the same as the search range.

The size of the target merge table is the same as the search range. That is, the target merge table is in one-to-one correspondence to motion vector search points.

Optionally, the server follows the order of numbers until 5 pieces of target candidate motion vector information and the merge motion vector information corresponding to the target candidate motion vector information are saved, to obtain the target merge table.

As shown in FIG. 5, it is assumed that numbers of types of all cand_mv are greater than 0. The server sequentially acquires cand_mv1 and determines whether two components mvx and mvy of cand_mv1 fall within the search range ({0<mvx<9}, {0<mvy<9}), and if the two components fall within the range and cand_mv1 meets the preset condition, acquires merge motion vector information corresponding to cand_mv1. In this case, 4 pieces of merge motion vector information corresponding to cand_mv1 are saved, and the server saves the 4 pieces of merge motion vector information in parallel.

The server acquires cand_mv2 and determines whether two components mvx and mvy of cand_mv2 fall within the search range ({0<mvx<9}, {0<mvy<9}), and if the two components fall within the range and cand_mv2 meets the preset condition, acquires merge motion vector information corresponding to cand_mv2. In this case, 2 pieces of merge motion vector information corresponding to cand_mv2 are saved, and the server saves the 2 pieces of merge motion vector information in parallel.

The server acquires cand_mv3 and determines whether two components mvx and mvy of cand_mv3 fall within the search range ({0<mvx<9}, {0<mvy<9}), and if cand_mv3 is not within the range, excludes cand_mv3.

The server acquires cand_mv4 and determines whether two components mvx and mvy of cand_mv4 fall within the search range ({0<mvx<9}, {0<mvy<9}), and if the two components fall within the range and cand_mv4 meets the preset condition, acquires merge motion vector information corresponding to cand_mv4. In this case, 1 piece of merge motion vector information corresponding to cand_mv4 is saved.

The server acquires cand_mv5 and determines whether two components mvx and mvy of cand_mv5 fall within the search range ({0<mvx<9}, {0<mvy<9}), and if the two components fall within the range and cand_mv5 meets the preset condition, acquires merge motion vector information corresponding to cand_mv5. In this case, 2 pieces of merge motion vector information corresponding to cand_mv5 are saved, and the server saves the 2 pieces of merge motion vector information in parallel. When cand_mv within the search range has been saved, the target merge table is generated.

Optionally, if the number of cand_mv is increased, merge motion vector information corresponding to the increased cand_mv is acquired accordingly.

In this embodiment, candidate motion vectors are sequentially acquired, and when it is determined that the candidate motion vectors fall within the range and the preset condition is met, merge motion vector information corresponding to the candidate motion vectors are acquired, to generate a target merge table, so that during subsequent use of the target merge table, comparison of each estimated motion vector and each candidate motion vector is reduced, and computing efficiency in the merge mode is improved.

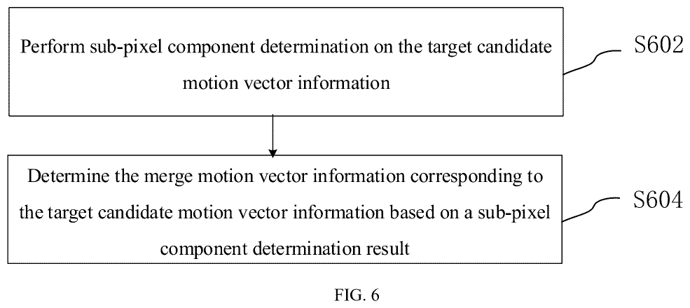

In an exemplary embodiment, as shown in FIG. 6, acquiring the merge motion vector information corresponding to the target candidate motion vector information includes step S602 to step S604.

In step S602, sub-pixel component determination is performed on the target candidate motion vector information.

The target candidate motion vector information may be a decimal, that is, a sub-pixel component. The target candidate motion vector information may include an X-axis component mvx and a Y-axis component mvy.

Optionally, the server determines mvx and mvy of the target candidate motion vector information in parallel.

In step S604, the merge motion vector information corresponding to the target candidate motion vector information is determined based on a sub-pixel component determination result.

The determination result may be that mvx is a sub-pixel component or mvy is a sub-pixel component, or that mvx and mvy are both sub-pixel components, or that neither mvx nor mvy is a sub-pixel component.

Optionally, the server acquires different amounts of merge motion vector information based on determination results of mvx and mvy.

In this embodiment, the merge motion vector information corresponding to the target candidate motion vector information is determined through determination results of sub-pixel components with different precision, which can improve accuracy of the acquired merge motion vector information.

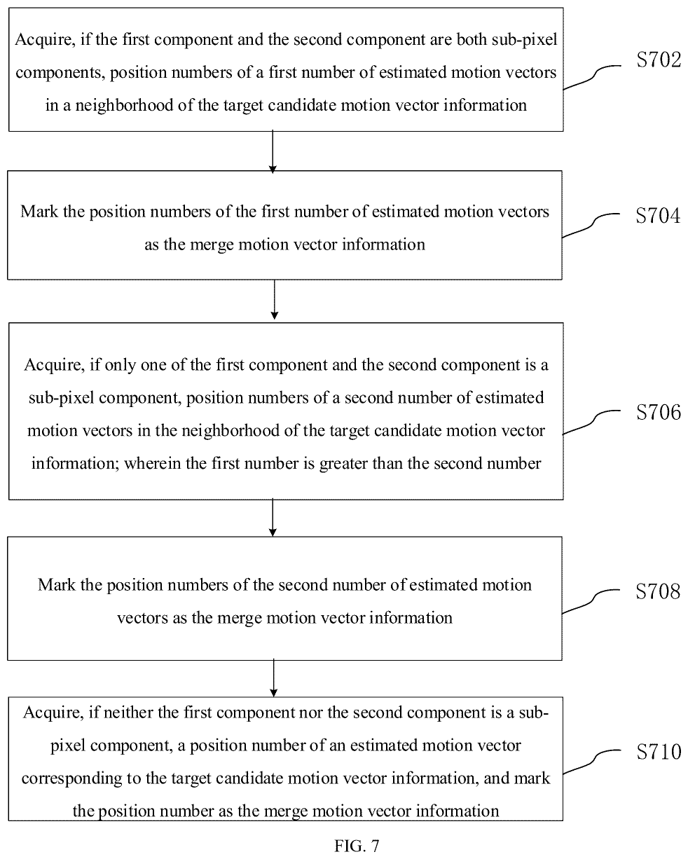

Following the previous exemplary embodiment, as shown in FIG. 7, the target candidate motion vector information includes a first component and a second component, and determining the merge motion vector information corresponding to the target candidate motion vector information based on the sub-pixel component determination result includes step S702 to step S710.

In step S702, if the first component and the second component are both sub-pixel components, position numbers of a first number of estimated motion vectors in a neighborhood of the target candidate motion vector information are acquired.

The first component may be an X-axis component or a Y-axis component. If the first component is the X-axis component, the corresponding second component is the Y-axis component.

Optionally, assuming that, in a 4-neighborhood search, mvx and mvy are both sub-pixel components, such as cand_mv1 in FIG. 5, the server acquires position numbers of the 4 estimated motion vectors in the neighborhood of the target candidate motion vector information.

Optionally, for other types of neighborhood searches, the server acquires position numbers of corresponding estimated motion vectors in the neighborhood of the target candidate motion vector information.

In step S704, the position numbers of the first number of estimated motion vectors are marked as the merge motion vector information.

Optionally, when mvx and mvy of cand_mv are both sub-pixel components, four estimated motion vectors est_mv marked by the merge table are respectively:

$$est\_mv1 = mvx [ 15 : 2 ] + mvy [ 15 : 2 ] * offsetx$$

$$est\_mv2 = mvx [ 15 : 2 ] + 1 + mvy [ 15 : 2 ] * offsetx$$

$$est\_mv3 = mvx [ 15 : 2 ] + ( mvy [ 15 : 2 ] + 1 ) * offsetx$$

$$est\_mv4 = mvx [ 15 : 2 ] + 1 + ( mvy [ 15 : 2 ] + 1 ) * offsetx$$

where mvx and mvy are fixed-point decimals, two lower digits are decimal places, and offset denotes a horizontal search width.

In step S706, if only one of the first component and the second component is a sub-pixel component, position numbers of a second number of estimated motion vectors in the neighborhood of the target candidate motion vector information are acquired, wherein the first number is greater than the second number.

The first number is greater than the second number. That is, estimated motion vector data in a neighborhood of cand_mv when mvx and mvy of cand_mv are both sub-pixel components is more than corresponding estimated motion vector data when only one of mvx and mvy of cand_mv is a sub-pixel component.

Optionally, if only one of mvx and mvy is a sub-pixel component, such as cand_mv2 in FIG. 5, the server acquires the position numbers of the second number of estimated motion vectors in the neighborhood of the target candidate motion vector information.

In step S708, the position numbers of the second number of estimated motion vectors are marked as the merge motion vector information.

Optionally, two est_mv in the neighborhood acquired by the server are marked as merge_mv.

In step S710, if neither the first component nor the second component is a sub-pixel component, a position number of an estimated motion vector corresponding to the target candidate motion vector information is acquired and is marked as the merge motion vector information.

Optionally, if there are no sub-pixel components in mvx and mvy, that is, if cand_mv is equal to a certain est_mv, such as cand_mv4 in FIG. 5, the estimated motion vector is marked as the merge motion vector information.

In this embodiment, be determining the sub-pixel components, different numbers of estimated motion vectors can be acquired, and these estimated motion vectors are denoted as merge motion vector information, so that the merge motion vector information of the estimated motion vectors can be read from the target merge table later.

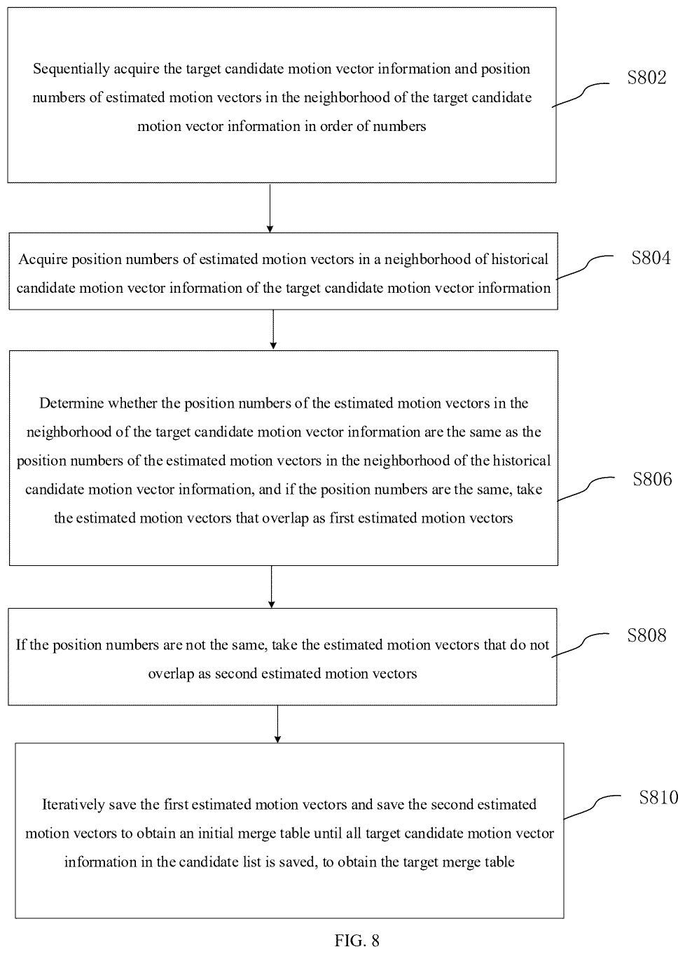

In an exemplary embodiment, as shown in FIG. 8, obtaining the target merge table according to the target candidate motion vector information and the merge motion vector information corresponding to the target candidate motion vector information includes step S802 to step S804.

In step S802, the target candidate motion vector information and position numbers of estimated motion vectors in the neighborhood of the target candidate motion vector information are sequentially acquired in order of numbers.

Optionally, in a case that the target candidate motion vector information is not the last one, the server sequentially acquires target candidate motion vector information, such as cand_mv1, and position numbers of estimated motion vectors est_mv in a neighborhood of the target candidate motion vector information cand_mv1 in order of numbers,
to obtain an initial merge table. The server continuously acquires cand_mv2 and position numbers of est_mv in a neighborhood of cand_mv2, to obtain an updated initial merge table. In this case, the initial merge table includes information of cand_mvl and cand_mv2, and steps are continuously performed by analogy.

In step S804, position numbers of estimated motion vectors in a neighborhood of historical candidate motion vector information of the target candidate motion vector information are acquired.

Optionally, for the historical candidate motion vector information of the target candidate motion vector information, if the target candidate motion vector information is cand_mv2, the historical candidate motion vector information is cand_mv1, if the target candidate motion vector information is cand_mv3, the historical candidate motion vector information is cand_mv2 and cand_mv1, and so on.

In step S806, it is determined whether the position numbers of the estimated motion vectors in the neighborhood of the target candidate motion vector information are the same as the position numbers of the estimated motion vectors in the neighborhood of the historical candidate motion vector information, and if the position numbers are the same, the estimated motion vectors that overlap are taken as first estimated motion vectors.

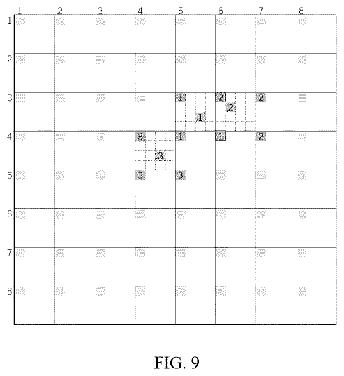

Optionally, if the target candidate motion vector information is cand_mv2, the historical candidate motion vector information is cand_mv1. As shown in FIG. 9, position numbers of four estimated motion vectors in the neighborhood of cand_mv2 are (6,3) (7,3) (7,4), and (6,4). In this case, information of cand_mv1 has been stored in the initial merge table.

Optionally, position numbers of four estimated motion vectors in the neighborhood of cand_mv1 acquired by the server are (5,3) (6,3) (6,4), and (5,4) respectively. (6,3) and (6,4) where cand_mv1 and cand_mv2 overlap are two first estimated motion vectors.

In step S808, if the position numbers are not the same, the estimated motion vectors that do not overlap are taken as second estimated motion vectors.

Optionally, if the position numbers are not the same, the server takes the estimated motion vectors that do not overlap as second estimated motion vectors. As shown in FIGS. 9, (7,3) and (7,4) are estimated motion vectors of cand_mv2 that do not overlap, that is, the second estimated motion vectors.

In step S810, the first estimated motion vectors are iteratively saved and the second estimated motion vectors are saved to obtain an initial merge table until all target candidate motion vector information in the candidate list is saved, to obtain the target merge table.

Optionally, in a case that the target candidate motion vector information is not the last one, the server sequentially acquires target candidate motion vector information in order of numbers. For example, the first target candidate motion vector information is cand mv1. In this case, there is no historical candidate motion vector information. Therefore, estimated motion vectors in a neighborhood of the target candidate motion vector information cand mv1 are all second estimated motion vectors. Positions numbers of the second estimated motion vectors est_mv are acquired, to obtain the initial merge table. The server continuously acquires cand_mv2 and position numbers of first estimated motion vectors est_mv and second estimated motion vectors est_mv in a neighborhood of cand_mv2, to obtain an updated initial merge table. In this case, the initial merge table includes information of cand_mv1 and cand_mv2, and steps are continuously performed by analogy. Until the last target candidate motion vector information in the candidate list is saved, the target merge table is obtained.

Optionally, the server saves the second estimated motion vectors while iteratively saving the first estimated motion vectors. The server processes the first estimated motion vectors and the second estimated motion vectors in parallel and saves them to the initial merge table, thereby improving efficiency.

Optionally, if the number of cand_mv is expanded to 6, when information of the 6^{th}cand_mv is saved, the target merge table is obtained. The number of cand_mv may be expanded according to an actual situation, which is not limited herein. In this embodiment, almost no additional time is consumed, reducing an influence of expansion of the number of cand_mv on timing of peripheral modules.

In this embodiment, the first estimated motion vectors in the initial table are iterated until all target candidate motion vector information in the candidate list is completed, comparison of each cand_mv is taken as a cycle, and it takes only a number of cycles the same as the number of cand_mv to obtain the target merge table, which can flexibly expand the number of cand_mv and consumes almost no additional time, thereby reducing the influence of expansion of the number of cand_mv on the timing of the peripheral modules.

In an exemplary embodiment, iteratively saving the first estimated motion vectors and saving the second estimated motion vectors to obtain the initial merge table includes: saving the target candidate motion vector information by taking position numbers of the first estimated motion vectors and position numbers of the second estimated motion vectors after iteration in the neighborhood of the target candidate motion vector information as indexes, to obtain the initial merge table.

Optionally, in a case that the target candidate motion vector information is not the last one, the server first establishes an empty table with a same size as the search range. The server takes position numbers of estimated motion vectors in the neighborhood of cand_mv1 as indexes, and saves cand_mv1 to the empty table, to obtain the initial merge table. The server takes position numbers of the first estimated motion vectors and position numbers of the second estimated motion vectors after iteration in the neighborhood of cand mv2 as indexes, and updates cand_mv2 to the initial merge table. The server takes position numbers of the first estimated motion vectors and position numbers of the second estimated motion vectors after iteration in the neighborhood of cand_mv3 as indexes, and updates cand_mv3 to the initial merge table. Until the last cand_mv is updated, the target merge table is obtained.

In this embodiment, the target candidate motion vector information is saved by taking position numbers of estimated motion vectors as indexes, and a relationship between position numbers of motion vectors and target candidate motion vector information can be obtained. Therefore, during a subsequent motion vector search, the merge motion vector information is obtained according to the relationship between the position numbers of the motion vectors and the target candidate motion vector information.

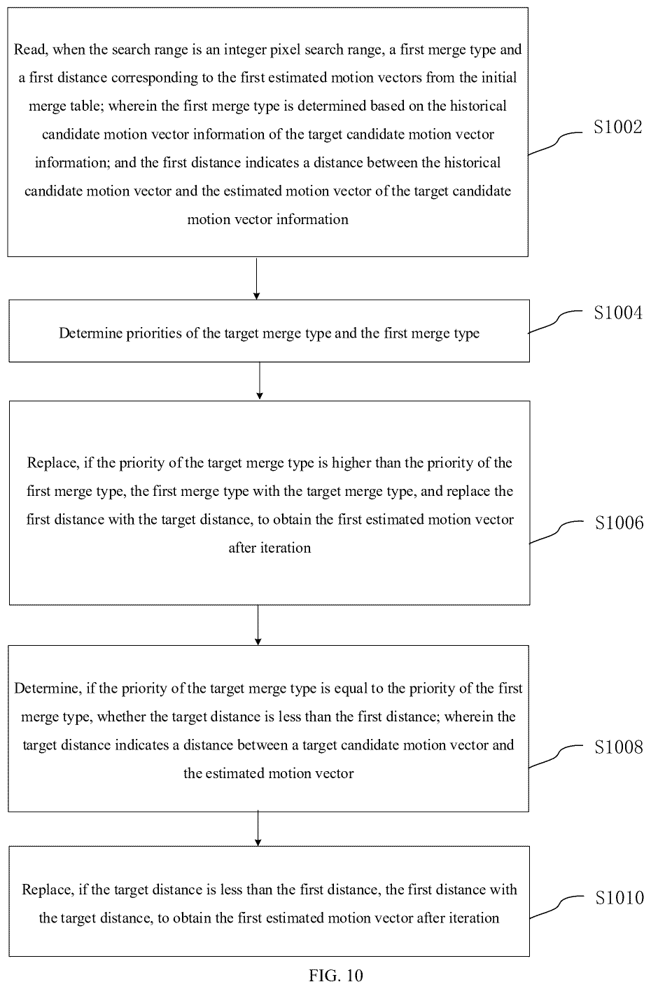

In an exemplary embodiment, as shown in FIG. 10, the target candidate motion vector information includes a target merge type and a target distance, and prior to taking the position numbers of the first estimated motion vectors after iteration in the neighborhood of the target candidate motion vector information as the indexes, the method includes step S1002 to step S1010.

In step S1002, when the search range is an integer pixel search range, a first merge type and a first distance corresponding to the first estimated motion vectors are read from the initial merge table, wherein the first merge type is determined based on the historical candidate motion vector information of the target candidate motion vector information, and the first distance indicates a distance between the historical candidate motion vector and the estimated motion vector of the target candidate motion vector information.

The first merge type is determined based on the historical candidate motion vector information of the target candidate motion vector information. The first distance indicates a distance between the historical candidate motion vector and the estimated motion vector of the target candidate motion vector information. When an estimated motion vector in the neighborhood of the target candidate motion vector information overlaps with an estimated motion vector in the neighborhood of the historical candidate motion vector information of the target candidate motion vector information, the overlapping estimated motion vector may be taken as the first estimated motion vector. As shown in FIG. 9, position numbers of four estimated motion vectors in the neighborhood of cand_mv1 are (5,3), (6,3), (6,4), and (5,4) respectively, position numbers of four estimated motion vectors in the neighborhood of cand_mv2 (6,3), (7,3), (7,4), and (6,4) respectively, (6,3) and (6,4) where cand_mv1 and cand_mv2 overlap are two first estimated motion vectors, and (7,3) and (7,4) are second estimated motion vectors. Position numbers of four estimated motion vectors in the neighborhood of cand_mv3 are (4,4), (5,4), (5,5), and (4,5) respectively, (5,4) where cand_mv1 and cand_mv3 overlap is also a first estimated motion vector, and (4,4), (5,5), and (4,5) are second estimated motion vectors.

Optionally, in practical applications, up to 5 pieces of candidate motion vector information cand_mv are stored in the candidate list, which are cand_mv1, cand_mv2, cand_mv3, cand_mv4, and cand_mv5 respectively. It is assumed that relevant information of cand_mv1 has been stored in the initial merge, including merge types and distances. In this case, the server acquires estimated motion vectors in the neighborhood of cand_mv2, and overlapping with the estimated motion vectors in the neighborhood of cand_mv2, as shown in

FIGS. 9, (6,3) and (6,4) are two first estimated motion vectors. The server acquires a merge type of cand_mv1 corresponding to the first estimated motion vector (6,3) and a distance between cand_mv1 and the first estimated motion vector (6,3) in parallel, which serve as an original merge type and an original distance respectively.

Optionally, when the target candidate motion vector information is cand_mv3, the server acquires a merge type of cand_mv2 corresponding to the first estimated motion vector (5,4) and a distance between cand_mv2 and the first estimated motion vector (5,4) in parallel, which serve as an original merge type and an original distance respectively.

In step S1004, priorities of the target merge type and the first merge type are determined.

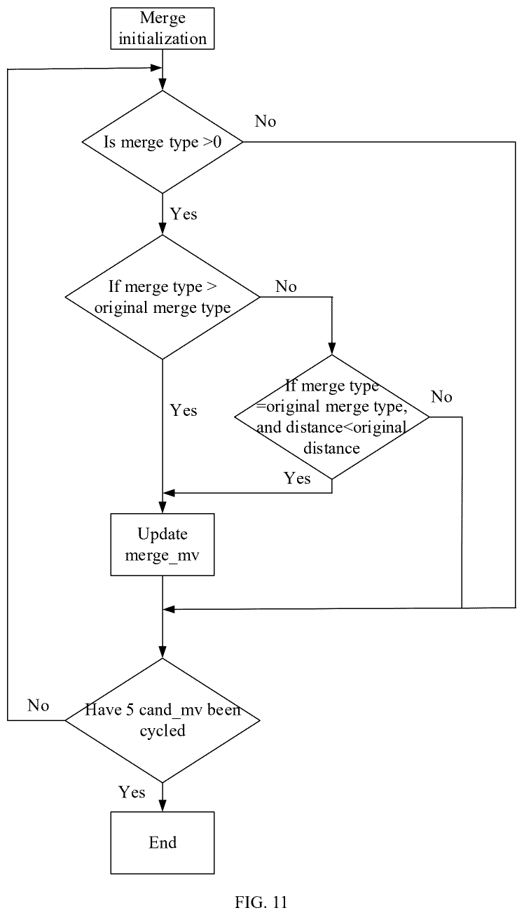

Optionally, it is assumed that cand_mv1 and cand_mv2 are both square merge, and the server acquires the target merge information of the target candidate motion vector information. If the two first estimated motion vectors (6,3) and (6,4) are still taken as an example, as shown in FIG. 11, when determining whether a number of the target merge type of cand_mv2 is greater than 0, the server continuously determines that priorities of the target merge type of cand_mv2 and the first merge type of cand_mv1 are both merge and are the same.

In step S1006, if the priority of the target merge type is higher than the priority of the first merge type, the first merge type is replaced with the target merge type, and the first distance is replaced with the target distance, to obtain the first estimated motion vector after iteration.

Optionally, still as shown in FIG. 11, if the priority of the target merge type of cand_mv2 is higher than the priority of the first merge type of cand_mv1, the first merge type corresponding to the updated first estimated motion vector is replaced with the target merge type, the first distance is replaced with the target distance, and the target merge type and the target distance corresponding to the first estimated motion vector are saved to the initial merge table. That is, in the initial merge table, the merge type and the distance of cand_mv1 originally corresponding to the first estimated motion vector are replaced with the merge type and the distance of cand mv2.

In step S1008, if the priority of the target merge type is equal to the priority of the first merge type, it is determined whether the target distance is less than the first distance, wherein the target distance indicates a distance between a target candidate motion vector and the estimated motion vector.

Optionally, still as shown in FIG. 11, the priorities of the target merge type of cand_mv2 and the first merge type of cand_mv1 are both merge and are the same. In this case, the server is required to further determine the distance of cand_mv2 and the distance of cand mv1.

Formulas for calculating a distance between cand_mv and est_mv are as follows:
a distance between cand_mv and est_mv on the upper left is:

$$Distance 00 = mvx [ 1 : 0 ] + mvy [ 1 : 0 ]$$

a distance between cand_mv and est_mv on the upper right is:

$$Distance 10 = \sim mvx [ 1 : 0 ] + 1 + mvy [ 1 : 0 ]$$

a distance between cand_mv and est_mv on the lower left is:

$$Distance 01 = mvx [ 1 : 0 ] + \sim mvy [ 1 : 0 ] + 1$$

a distance between cand_mv and est_mv on the lower right is:

$$Distance 11 = \sim mvx [ 1 : 0 ] + 1 + \sim mvy [ 1 : 0 ] + 1$$

In step S1010, if the target distance is less than the first distance, the first distance is replaced with the target distance, to obtain the first estimated motion vector after iteration.

Optionally, if the distance of cand_mv2 is less than the distance of cand_mv1, the server uses the closer cand_mv as the final merge_mv. That is, in the initial merge table, the server replaces the merge type and the distance of cand_mv1 originally corresponding to the first estimated motion vector with the merge type and the distance of cand_mv2.

It is to be noted that when a plurality of first estimated motion vectors are provided, the server updates the first estimated motion vectors in parallel. The server may further save second estimated motion vectors and at least one first estimated motion vector in a neighborhood of candidate motion vector information to the initial merge table at the same time and in parallel.

In this embodiment, by comparing the merge types and the distances, the closest merge_mv of the best merge type is selected as the final merge_mv, which can shorten iteration time and improve computing efficiency.

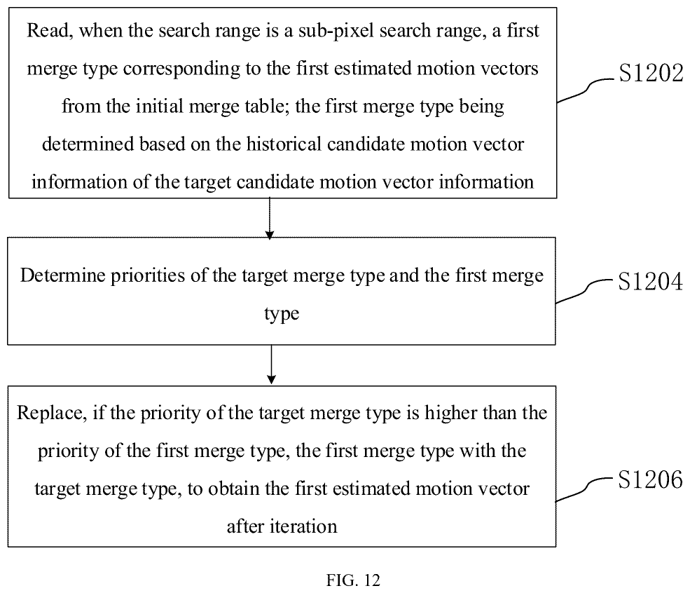

In an exemplary embodiment, as shown in FIG. 12, the target candidate motion vector information includes a target merge type, and prior to taking the position numbers of the first estimated motion vectors after iteration in the neighborhood of the target candidate motion vector information as the indexes, the method includes step S1202 to step S1206.

In step S1202, when the search range is a sub-pixel search range, a first merge type corresponding to the first estimated motion vectors is read from the initial merge table, the first merge type being determined based on the historical candidate motion vector information of the target candidate motion vector information.

In step S1204, priorities of the target merge type and the first merge type are determined.

In step S1206, if the priority of the target merge type is higher than the priority of the first merge type, the first merge type is replaced with the target merge type, and the target merge type corresponding to the first estimated motion vectors is saved to the initial merge table.

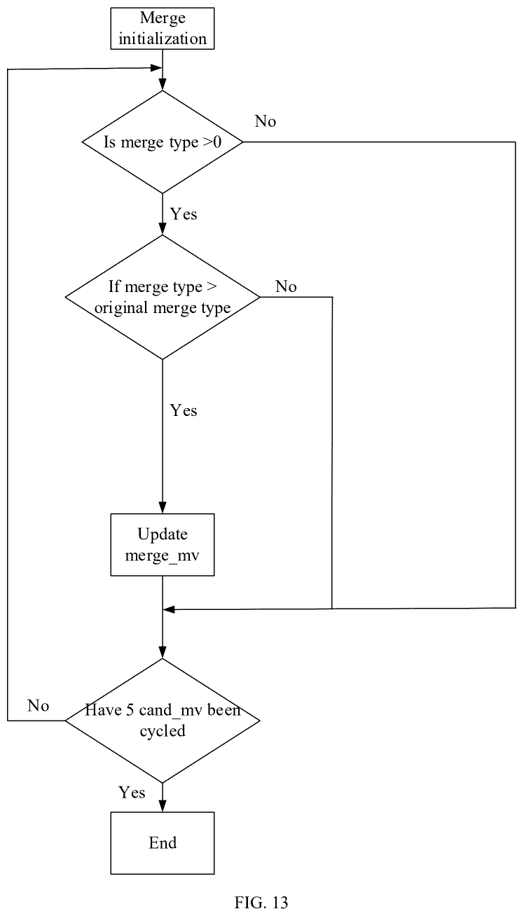

In practical applications, in order to further improve the coding efficiency, the merge mode may be also required to be added in the sub-pixel search stage. Since est_mv in the sub-pixel search is also one-quarter pixel precision, which is consistent with the precision of cand_mv, est_mv equal to cand_mv in the search range definitely exists. Then, a distance between cand_mv and est_mv is no longer determined in the sub-pixel search, and the remaining operations are consistent with those in the integer pixel search. A flowchart of determining merge_mv in a sub-pixel stage is shown in FIG. 13.

A sub-pixel target merge table is established according to the process in FIG. 13. If cand mv falls within the search range ({0<mvx<2}, {0<mvy<2}), cand_mv is saved as merge_mv in the merge table. Otherwise, cand_mv, such as cand_mv5 in FIG. 3b, is excluded.

In this embodiment, in order to further improve the coding efficiency, a merge mode in a sub-pixel search is expanded, and a sub-pixel target merge table can be constructed through the above steps, which can flexibly expand the sub-pixel target merge table, reduce the iteration time, and further improve computing efficiency.

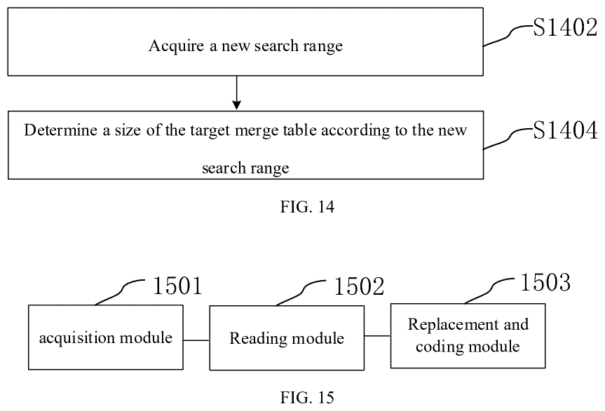

In an exemplary embodiment, as shown in FIG. 14, the inter-frame coding motion vector processing further includes step S1402 to step S1404.

In step S1402, a new search range is acquired.

In step S1404, a size of the target merge table is determined according to the new search range.

In practical applications, enlarging a search region of est_mv and improving search accuracy are common upgrade manners for video coding protocols. This change may be dealt with by parameterizing a data bit width. The change mainly affects cand_mv. For cand_mv, two components mvx and mvy of effective cand_mv should belong to:

$$\{ mvx : 0 < mvx [ [ {log}_{2} {block}_{width} ] + point : point ] < ( {block}_{width} + 1 ) \}$$

$$\{ mvy : 0 < mvy [ [ {log}_{2} {block}_{width} ] + point : point ] < ( {block}_{width} + 1 ) \}$$

where block_{width} denotes a search width, and point denotes a position of a decimal point of a fixed-point decimal.

Next, merge result information is saved in the merge table. A size of the merge table

is the same as the search range. Therefore, the size of the merge table is parameterized and consistent with the search range, that is,

$${size}_{table} = {block}_{width}^{2}$$

A 12*12 integer pixel motion vector search is an optimized and expanded form of an 8*8 search. The size of the merge table is parameterized according to the above formula, a merge table of size_{table}=12*12 is established, and at the same time, a bit width is parameterized. Then, an effective range of cand_mv may be obtained:

$$\{ mvx : 0 < mvx [ 5 : 2 ] < 13 \}$$

$$\{ mvy : 0 < mvy [ 5 : 2 ] < 13 \}$$

As can be seen, different search ranges may be matched through simple parameter configuration. At present, in actual engineering projects, expansion of the above 12*12 motion vector search merge mode has been applied.

In this embodiment, the size of the target merge table is determined through a new search range, which can achieve flexible expansion and easy operation.

In an exemplary embodiment, two stages are included. In a target merge table construction stage, it is assumed that there are 5 cand_mv, cand_mv1 and cand_mv2 are square merge, and the search range is ({0<mvx<9}, {0<mvy<9}). The server establishes a table that records only estimated motion vector information with the same size as the search range. The server determines a search range of cand_mv1, and in the search range, continues to determine that the merge type of cand_mv1 is square merge and the number is 3, which is greater than 0. Therefore, the preset condition is met. Cand_mv1 is stored into the above table that records only the estimated motion vector information, to obtain the initial merge table.

In this case, the server determines a search range of cand_mv2, and in the search range, continues to determine that the merge type of cand_mv2 is square merge and the number is 3, which is greater than 0. Therefore, the preset condition is met.

As shown in FIG. 9, position numbers of four estimated motion vectors corresponding to cand_mv1, which are (5,3) (6,3) (6,4), and (5,4) respectively, are recorded in the initial merge table. Position numbers of four estimated motion vectors in the neighborhood of cand_mv2 are (6,3) (7,3) (7,4), and (6,4) respectively. (6,3) (6,4) where cand_mv1 and cand_mv2 overlap are two first estimated motion vectors. In this case, cand_mv1 serves as the original merge type and distance. The priorities of the target merge type of cand_mv2 and the first merge type of cand_mv1 are both merge, and the determination result is that the priorities are the same. In this case, the server is required to further determine the distance of cand mv2 and the distance of cand_mv1. For the estimated motion vector (6,3), the distance of cand_mv2 is less than the distance of cand_mv1. Therefore, the information of cand_mv1 that the estimated motion vector (6,3) was originally recorded as in the initial merge table is now replaced with the information of cand_mv2. For the estimated motion vector (6,4), the distance of cand_mv2 is greater than the distance of cand_mv1. Therefore, there is no need to update the information of cand_mv1 that the estimated motion vector (6,4) was originally recorded as in the initial merge table. Until the last cand_mv5 is updated, the integer pixel target merge table is obtained.

In a target merge table usage stage, the server acquires an estimated motion vector between a current coded image block and a reference frame coded image block, and each estimated motion vector corresponds to a position number. According to the position number corresponding to each estimated motion vector, the corresponding merge motion vector information is read from the integer pixel target merge table. If the merge motion vector information exists, the estimated motion vector with the corresponding position number is replaced with the merge motion vector information, and the merge motion vector information is coded. The time of deciding candidate motion vector information in a video inter-frame coding merge mode is greatly reduced, thereby improving processing efficiency.

It should be understood that, although the steps in the flowcharts as referred to in the embodiments described above are shown in sequence as indicated by the arrows, the steps are not necessarily performed in the order indicated by the arrows. Unless otherwise clearly specified herein, the steps are performed without any strict sequence limitation, and may be performed in other orders. In addition, at least some steps in the flowcharts as referred to in the embodiments described above may include a plurality of steps or a plurality of stages, and such steps or stages are not necessarily performed at a same moment, and may be performed at different moments. The steps or stages are not necessarily performed in sequence, and the steps or stages and at least some of other steps or steps or stages of other steps may be performed in turn or alternately.

Based on the same inventive concept, embodiments of the present disclosure further provide an inter-frame coding motion vector processing apparatus configured to implement the inter-frame coding motion vector processing method as referred to above. An implementation solution for solving the problems that is provided by the apparatus is similar to the implementation solution of the above method. Therefore, for specific limitations in one or more embodiments of the inter-frame coding motion vector processing apparatus provided below, reference may be made to the limitations on the above inter-frame coding motion vector processing method. Details are not described herein again.

In an exemplary embodiment, as shown in FIG. 15, an inter-frame coding motion vector processing apparatus is provided, including: a first acquisition module 1501, a reading module 1502, and a replacement and coding module 1503.

The first acquisition module 1501 is configured to acquire an estimated motion vector between a current coded image block and a reference frame coded image block and a position number of the estimated motion vector.

The reading module 1502 is configured to read merge motion vector information corresponding to the position number from a target merge table according to the position number of the estimated motion vector. The target merge table includes a relationship between position numbers of estimated motion vectors and merge motion vector information corresponding to the position numbers of the estimated motion vectors.

The replacement and coding module 1503 is configured to replace the estimated motion vector corresponding to the position number with the merge motion vector information, and code the merge motion vector information.

In an exemplary embodiment, an inter-frame coding motion vector processing apparatus is provided, including:
a second acquisition module configured to acquire a search range;
a third acquisition module configured to sequentially acquire the target candidate motion vector information from a candidate list in order of numbers;
a fourth acquisition module configured to acquire, for each piece of the target candidate motion vector information within the search range, merge motion vector information corresponding to the target candidate motion vector information in a case that a preset condition is met, wherein the merge motion vector information is determined based on the position number of the estimated motion vector; and
a target merge module configured to obtain the target merge table according to the target candidate motion vector information and the merge motion vector information corresponding to the target candidate motion vector information, a size of the target merge table being the same as the search range.

In an exemplary embodiment, the fourth acquisition module includes:
a sub-pixel classification determination unit configured to perform sub-pixel component determination on the target candidate motion vector information; and
a merge motion vector information determination unit configured to determine the merge motion vector information corresponding to the target candidate motion vector information based on a sub-pixel component determination result.

In an exemplary embodiment, the target candidate motion vector information includes a first component and a second component, and the merge motion vector information determination unit includes:
a first acquisition subunit configured to acquire, if the first component and the second component are both sub-pixel components, position numbers of a first number of estimated motion vectors in a neighborhood of the target candidate motion vector information;
a first marking subunit configured to mark the position numbers of the first number of estimated motion vectors as the merge motion vector information;
a second acquisition subunit configured to acquire, if only one of the first component and the second component is a sub-pixel component, position numbers of a second number of estimated motion vectors in the neighborhood of the target candidate motion vector information, wherein the first number is greater than the second number;
a second marking subunit configured to mark the position numbers of the second number of estimated motion vectors as the merge motion vector information; and
an acquisition and marking subunit configured to acquire, if neither the first component nor the second component is a sub-pixel component, a position number of an estimated motion vector corresponding to the target candidate motion vector information, and mark the position number as the merge motion vector information.

In an embodiment, the target merge module includes:
a first acquisition unit configured to sequentially acquire the target candidate motion vector information and position numbers of estimated motion vectors in the neighborhood of the target candidate motion vector information in order of numbers;
a second acquisition unit configured to acquire position numbers of estimated motion vectors in a neighborhood of historical candidate motion vector information of the target candidate motion vector information;
an overlapping determination unit configured to determine whether the position numbers of the estimated motion vectors in the neighborhood of the target candidate motion vector information are the same as the position numbers of the estimated motion vectors in the neighborhood of the historical candidate motion vector information, if the position numbers are the same, take the estimated motion vectors that overlap as first estimated motion vectors, and if the position numbers are not the same, take the estimated motion vectors that do not overlap as second estimated motion vectors; and
an iterative saving unit configured to iteratively save the first estimated motion vectors and save the second estimated motion vectors to obtain an initial merge table until all target candidate motion vector information in the candidate list is saved, to obtain the target merge table.

In an embodiment, the iterative saving unit is further configured to save the target candidate motion vector information by taking position numbers of the first estimated motion vectors and position numbers of the second estimated motion vectors after iteration in the neighborhood of the target candidate motion vector information as indexes, to obtain the initial merge table.

In an embodiment, the target candidate motion vector information includes a target merge type and a target distance, and the target merge module includes:
a first reading unit configured to read, when the search range is an integer pixel search range, a first merge type and a first distance corresponding to the first estimated motion vectors from the initial merge table, wherein the first merge type is determined based on the historical candidate motion vector information of the target candidate motion vector information, and the first distance indicates a distance between the historical candidate motion vector and the estimated motion vector of the target candidate motion vector information;
a first determination unit configured to determine priorities of the target merge type and the first merge type;
a first replacement unit configured to replace, if the priority of the target merge type is higher than the priority of the first merge type, the first merge type with the target merge type, and replace the first distance with the target distance, to obtain the first estimated motion vector after iteration;
a second determination unit configured to determine, if the priority of the target merge type is equal to the priority of the first merge type, whether the target distance is less than the first distance, wherein the target distance indicates a distance between a target candidate motion vector and the estimated motion vector; and
a second replacement unit configured to replace, if the target distance is less than the first distance, the first distance with the target distance, to obtain the first estimated motion vector after iteration.

In an embodiment, the target candidate motion vector information includes a target merge type, and the target merge module further includes:
a second reading unit configured to read, when the search range is a sub-pixel search range, a first merge type corresponding to the first estimated motion vectors from the initial merge table, the first merge type being determined based on the historical candidate motion vector information of the target candidate motion vector information;
a third determination unit configured to determine priorities of the target merge type and the first merge type; and
a third replacement unit configured to replace, if the priority of the target merge type is higher than the priority of the first merge type, the first merge type with the target merge type, to obtain the first estimated motion vector after iteration.

In an embodiment, in an exemplary embodiment, an inter-frame coding motion vector processing apparatus is provided, further including:
a fifth acquisition module configured to acquire a new search range; and
a size determination module configured to determine a size of the target merge table according to the new search range.

The modules in the above inter-frame coding motion vector processing apparatus may be implemented entirely or partially by software, hardware, or a combination thereof. The above modules may be built in or independent of a processor of a computer device in a hardware form, or may be stored in a memory of the computer device in a software form, to facilitate the processor to invoke and perform operations corresponding to the above modules.

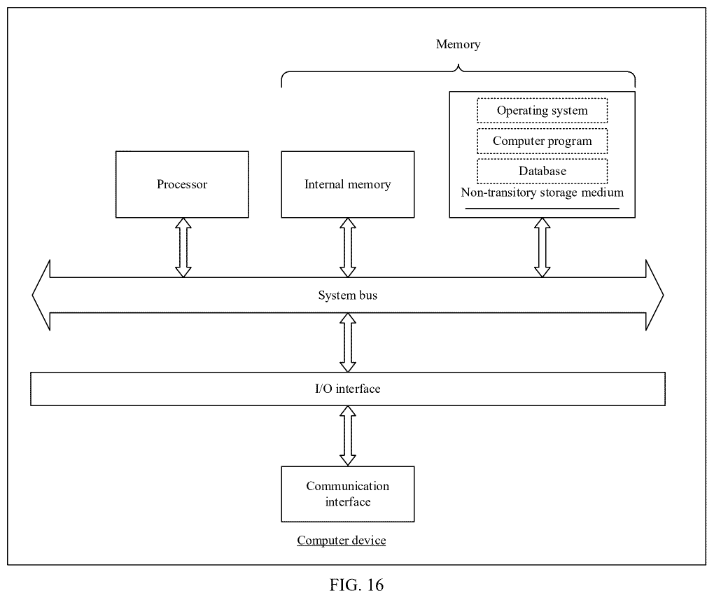

In an exemplary embodiment, a computer device is provided. The computer device may be a server, and a diagram of an internal structure thereof may be shown in FIG. 16. The computer device includes a processor, a memory, an input/output (I/O) interface, and a communication interface. The processor, the memory, and the I/O interface are connected by a system bus. The communication interface is connected to the system bus by the I/O interface. The processor of the computer device is configured to provide computing and control capabilities. The memory of the computer device includes a non-volatile storage medium and an internal memory. The non-volatile storage medium stores an operating system, a computer program, and a database. The internal memory provides an environment for running of the operating system and the computer program in the non-volatile storage medium. The database of the computer device is configured to store motion vector data. The I/O interface of the computer device is configured to exchange information between the processor and an external device. The communication interface of the computer device is configured to communicate with an external terminal through a network connection. The computer program is executed by the processor to implement an inter-frame coding motion vector processing method.

Those skilled in the art may understand that, the structure shown in FIG. 16 is only a block diagram of a partial structure related to a solution of the present disclosure, which does not constitute a limitation on the computer device to which the solution of the present disclosure is applied. Specifically, the computer device may include more or fewer components than those shown in the figure, or some components may be combined, or a different component deployment may be used.

Those of ordinary skill in the art may understand that some or all procedures in the methods in the foregoing embodiments may be implemented by a computer program instructing related hardware, the computer program may be stored in a non-volatile computer-readable storage medium, and when the computer program is executed, the procedures in the foregoing method embodiments may be implemented. Any reference to the memory, database, or other media used in the embodiments provided in the present disclosure may include at least one of a non-volatile memory and a volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a stage change memory (PCM), a graphene memory, and the like. The volatile memory may include a random access memory (RAM) or an external cache. By way of illustration instead of limitation, the RAM is available in a variety of forms, such as a static random access memory (SRAM) or a dynamic random access memory (DRAM). The database as referred to in the embodiments provided in the present disclosure may include at least one of a relational database and a non-relational database. The non-relational database may include a blockchain-based distributed database, and the like, but is not limited thereto. The processor as referred to in the embodiments provided in the present disclosure may be a general-purpose processor, a central processing unit, a graphics processor, a digital signal processor, a programmable logic device, a data processing logic device based on quantum computing, an artificial intelligence (AI) processor, and the like, but is not limited thereto.

The technical features in the above embodiments may be randomly combined. For concise description, not all possible combinations of the technical features in the above embodiments are described. However, all the combinations of the technical features are to be considered as falling within the scope described in this specification provided that they do not conflict with each other.

The above embodiments only describe several implementations of the present disclosure, and their description is specific and detailed, but cannot therefore be understood as a limitation on the patent scope of the present disclosure. It should be noted that those of ordinary skill in the art may further make variations and improvements without departing from the conception of the present disclosure, and these all fall within the protection scope of the present disclosure. Therefore, the protection scope of the present disclosure should be subject to the appended claims.

1. An inter-frame coding motion vector processing method, comprising:
acquiring an estimated motion vector between a current coded image block and a reference frame coded image block and a position number of the estimated motion vector;
reading merge motion vector information corresponding to the position number from a target merge table according to the position number of the estimated motion vector; the target merge table comprising a relationship between position numbers of estimated motion vectors and merge motion vector information corresponding to the position numbers of the estimated motion vectors;
replacing the estimated motion vector corresponding to the position number with the merge motion vector information, and coding the merge motion vector information.

2. The method according to claim 1, wherein target candidate motion vector information carries a number; and the target merge table is constructed by:
acquiring a search range;
sequentially acquiring the target candidate motion vector information from a candidate list in order of numbers;
acquiring, for each piece of the target candidate motion vector information within the search range, merge motion vector information corresponding to the target candidate motion vector information in a case that a preset condition is met, wherein the merge motion vector information is determined based on the position number of the estimated motion vector;
obtaining the target merge table according to the target candidate motion vector information and the merge motion vector information corresponding to the target candidate motion vector information, a size of the target merge table being the same as the search range.

3. The method according to claim 2, wherein acquiring the merge motion vector information corresponding to the target candidate motion vector information comprises:
performing sub-pixel component determination on the target candidate motion vector information;
determining the merge motion vector information corresponding to the target candidate motion vector information based on a sub-pixel component determination result.

4. The method according to claim 3, wherein the target candidate motion vector information comprises a first component and a second component; and determining the merge motion vector information corresponding to the target candidate motion vector information based on the sub-pixel component determination result comprises:
acquiring, if the first component and the second component are both sub-pixel components, position numbers of a first number of estimated motion vectors in a neighborhood of the target candidate motion vector information;
marking the position numbers of the first number of estimated motion vectors as the merge motion vector information;
acquiring, if only one of the first component and the second component is a sub-pixel component, position numbers of a second number of estimated motion vectors in the neighborhood of the target candidate motion vector information; wherein the first number is greater than the second number;
marking the position numbers of the second number of estimated motion vectors as the merge motion vector information;
acquiring, if neither the first component nor the second component is a sub-pixel component, a position number of an estimated motion vector corresponding to the target candidate motion vector information, and marking the position number as the merge motion vector information.

5. The method according to claim 4, wherein obtaining the target merge table according to the target candidate motion vector information and the merge motion vector information corresponding to the target candidate motion vector information comprises:
sequentially acquiring the target candidate motion vector information and position numbers of estimated motion vectors in the neighborhood of the target candidate motion vector information in order of numbers;
acquiring position numbers of estimated motion vectors in a neighborhood of historical candidate motion vector information of the target candidate motion vector information;
determining whether the position numbers of the estimated motion vectors in the neighborhood of the target candidate motion vector information are the same as the position numbers of the estimated motion vectors in the neighborhood of the historical candidate motion vector information, and if the position numbers are the same, taking the estimated motion vectors that overlap as first estimated motion vectors;
if the position numbers are not the same, taking the estimated motion vectors that do not overlap as second estimated motion vectors;
iteratively saving the first estimated motion vectors and saving the second estimated motion vectors to obtain an initial merge table until all target candidate motion vector information in the candidate list is saved, to obtain the target merge table.

6. The method according to claim 5, wherein iteratively saving the first estimated motion vectors and saving the second estimated motion vectors to obtain the initial merge table comprises:
saving the target candidate motion vector information by taking position numbers of the first estimated motion vectors and position numbers of the second estimated motion vectors after iteration in the neighborhood of the target candidate motion vector information as indexes, to obtain the initial merge table.

7. The method according to claim 6, wherein the target candidate motion vector information comprises a target merge type and a target distance; and the method comprises: prior to taking the position numbers of the first estimated motion vectors after iteration in the neighborhood of the target candidate motion vector information as the indexes,
reading, when the search range is an integer pixel search range, a first merge type and a first distance corresponding to the first estimated motion vectors from the initial merge table; wherein the first merge type is determined based on the historical candidate motion vector information of the target candidate motion vector information; and the first distance indicates a distance between the historical candidate motion vector and the estimated motion vector of the target candidate motion vector information;
determining priorities of the target merge type and the first merge type;
replacing, if the priority of the target merge type is higher than the priority of the first merge type, the first merge type with the target merge type, and replacing the first distance with the target distance, to obtain the first estimated motion vector after iteration;
determining, if the priority of the target merge type is equal to the priority of the first merge type, whether the target distance is less than the first distance; wherein the target distance indicates a distance between a target candidate motion vector and the estimated motion vector;
replacing, if the target distance is less than the first distance, the first distance with the target distance, to obtain the first estimated motion vector after iteration.

8. The method according to claim 6, wherein the target candidate motion vector information comprises a target merge type; and the method comprises: prior to taking the position numbers of the first estimated motion vectors after iteration in the neighborhood of the target candidate motion vector information as the indexes,
reading, when the search range is a sub-pixel search range, a first merge type corresponding to the first estimated motion vectors from the initial merge table; the first merge type being determined based on the historical candidate motion vector information of the target candidate motion vector information;
determining priorities of the target merge type and the first merge type;
replacing, if the priority of the target merge type is higher than the priority of the first merge type, the first merge type with the target merge type, to obtain the first estimated motion vector after iteration.

9. The method according to claim 2, further comprising:
acquiring a new search range;
determining a size of the target merge table according to the new search range.

10. An inter-frame coding motion vector processing apparatus, comprising:
a first acquisition module configured to acquire an estimated motion vector between a current coded image block and a reference frame coded image block and a position number of the estimated motion vector;
a reading module configured to read merge motion vector information corresponding to the position number from a target merge table according to the position number of the estimated motion vector; the target merge table comprising a relationship between position numbers of estimated motion vectors and merge motion vector information corresponding to the position numbers of the estimated motion vectors;
a replacement and coding module configured to replace the estimated motion vector corresponding to the position number with the merge motion vector information, and code the merge motion vector information.
